(19) United States
(12) Patent Application Publication
(10) Pub. No.: US 2015/0249414 A1
(43) Pub. Date: Sep. 3, 2015

(54) WIND TURBINE SYSTEMS AND METHODS FOR OPERATING THE SAME

(71) Applicant: General Electric Company, Schenectady, NY (US)

(72) Inventor: Sidney Allen Barker, Troutville, VA (US)

(73) Assignee: General Electric Company, Schenectady, NY (US)

(21) Appl. No.: 14/193,838

(22) Filed: Feb. 28, 2014

(51) Int. Cl. H02P 9/00; F03D 9/00; F03D 7/00

(52) U.S. Cl. CPC H02P 9/007; F03D 7/00; F03D 9/003

(57) ABSTRACT

Wind turbine systems and methods for operating wind turbine systems are provided. A method includes monitoring an operating condition of the wind turbine system, and determining whether the operating condition has exceeded a predetermined threshold. The method further includes switching a plurality of switches devices in a rotor side converter of a power converter of the wind turbine system in a normal switching mode if the operating condition is less than the predetermined threshold. The method further includes switching the plurality of switching devices in a short circuit switching mode if the operating condition is greater than or equal to the predetermined threshold. The method further includes switching the plurality of switching devices in the normal switching mode after switching in the short circuit mode if the operating condition decreases below the predetermined threshold and a secondary operating condition is below a secondary predetermined threshold.

### FIELD OF THE INVENTION

The present disclosure relates generally to wind turbines, and more particularly to methods for operating such wind turbines. In particular, the present disclosure is directed to the use of power converter switches to isolate power during transient power conditions, and to the use of multiple operating conditions to determine when to change switching modes.

### BACKGROUND OF THE INVENTION

Wind turbines have received increased attention as a renewable energy source. Wind turbines use the wind to generate electricity. The wind turns multiple blades connected to a rotor. The spin of the blades caused by the wind spins a shaft of the rotor, which connects to a generator that generates electricity. Certain wind turbines include a doubly fed induction generator (DFIG) to convert wind energy into electrical power suitable for output to an electrical grid. DFIGs are typically connected to a converter that regulates the flow of electrical power between the DFIG and the grid. More particularly, the converter allows the wind turbine to output electrical power at the grid frequency regardless of the rotational speed of the wind turbine blades.

A typical DFIG system includes a wind driven DFIG having a rotor and a stator. The stator of the DFIG is coupled to the electrical grid through a stator bus. A power converter is used to couple the rotor of the DFIG to the electrical grid. The power converter can be a two-stage power converter including both a rotor side converter and a line side converter. The rotor side converter can receive alternating current (AC) power from the rotor via a rotor bus and can convert the AC power to a DC power. The line side converter can then convert the DC power to AC power having a suitable output frequency, such as the grid frequency. The AC power is provided to the electrical grid via a line bus. An auxiliary power feed can be coupled to the line bus to provide power for components used in the wind turbine system, such as fans, pumps, motors, and other components of the wind turbine system.

A typical DFIG system includes a two-winding transformer having a high voltage primary (e.g. greater than 12 KVAC) and a low voltage secondary (e.g. 575 VAC, 690 VAC, etc.) to couple the DFIG system to the electrical grid. The high voltage primary can be coupled to the high voltage electrical grid. The stator bus providing AC power from the stator of the DFIG and the line bus providing AC power from the power converter can be coupled to the low voltage secondary. In this system, the output power of the stator and the output power of the power converter are operated at the same voltage and combined into the single transformer secondary winding at the low voltage.

More recently, DFIG systems have included a three winding transformer to couple the DFIG system to the electrical grid. The three winding transformer can have a high voltage (e.g. greater than 12 KVAC) primary winding coupled to the electrical grid, a medium voltage (e.g. 6 KVAC) secondary winding coupled to the stator bus, and a low voltage (e.g. 575 VAC, 690 VAC, etc.) auxiliary winding coupled to the line bus. The three winding transformer arrangement can be preferred in increased output power systems (e.g. 3 MW systems) as it reduces the current in the stator bus and other components on the stator side of the DFIG.

During operation of wind turbine systems, including DFIG systems, various grid faults can occur, which result in a disconnect between generation of power by the wind turbine and receipt of that power by the grid. This can result in excessive energy in the power converter, which can cause damage to the converter.

Various approaches have been utilized to reduce the risk of overvoltage conditions in power converters. For example, crowbars have been utilized to prevent excess energy from reaching the power converter when grid faults occur. More recently, dynamic brake systems have been utilized. However, the additional components required for these approaches can add cost and complexity to the system.

More recently, the switches utilized in the power converter have been utilized to reduce the risk of overvoltage conditions. U.S. Pat. No. 7,239,036 to D'Atre et al., which is incorporated by reference in its entirety herein, discloses a specific pattern of switching which allows for short circuiting among the leads of a rotor bus of a generator of the system, this preventing excess energy from being supplied to the power converter.

However, issues can occur when the switches are switched from such short circuiting mode back to the normal operating mode. For example, switching from the short circuiting mode may occur after the DC link voltage level is below a predetermined level. However, the current level in the circuit may remain excessively high, such that switching from the short circuiting mode back to the normal operating mode allows excessive energy to flow from the previously shorted generator circuit into the dc link, causing a spike in the DC link voltage level. In some cases, the spike may be above the original high voltage level that caused initial switching in the short circuit mode. This can cause the switches to engage in a loop of switching between the short circuiting mode and the normal operating mode, with each successive loop potentially resulting in a higher DC link voltage. Further, such excessive levels can damage the power converter components and other components of the system, and/or can cause the system to fail to ride through a grid event.

Accordingly, improved wind turbine systems and methods for operating wind turbine systems are desired. In particular, improved overvoltage control systems and methods would be advantageous.

### BRIEF DESCRIPTION OF THE INVENTION

Aspects and advantages of the invention will be set forth in part in the following description, or may be obvious from the description, or may be learned through practice of the invention.

In one embodiment, the present disclosure is directed to a method for operating a wind turbine system. The method includes monitoring an operating condition of the wind turbine system, and determining whether the operating condition has exceeded a predetermined threshold. The method further includes switching a plurality of switches devices in a rotor side converter of a power converter of the wind turbine system in a normal switching mode if the operating condition is less than the predetermined threshold. The method further includes switching the plurality of switching devices in a short circuit switching mode if the operating condition is greater than or equal to the predetermined threshold. The method further includes switching the plurality of switching devices in the normal switching mode after switching in the short circuit mode if the operating condition decreases below the predetermined threshold and a secondary operating condition is below a secondary predetermined threshold.

In another embodiment, the present disclosure is directed to a wind turbine system. The wind turbine system includes a generator for generating power, and a rotor bus operable to provide three-phase power from a rotor of the generator. The wind turbine system further includes a power converter connected to the rotor bus, the power converter comprising a line side converter and a rotor side converter, the rotor side converter comprising a plurality of switching devices. The wind turbine system further includes a controller in communication with the power converter. The controller is operable to switch the plurality of switching devices in a short circuit switching mode if an operating condition is greater than or equal to a predetermined threshold. The controller is further operable to switch the plurality of switching devices in the normal switching mode after switching in the short circuit mode if the operating condition decreases below the predetermined threshold and a secondary operating condition is below a secondary predetermined threshold.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of a wind turbine according to one embodiment of the present disclosure;

FIG. 2 illustrates a perspective, internal view of a nacelle of a wind turbine according to one embodiment of the present disclosure;

FIG. 3 illustrates a schematic diagram of one embodiment of suitable components that may be included within a controller of a wind turbine;

FIG. 4 illustrates a DFIG wind turbine system according to one embodiment of the present disclosure;

FIG. 5 illustrates a portion of a power converter of a wind turbine system according to one embodiment of the present disclosure; and

FIG. 6 is a flow chart illustrating a method according to one embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

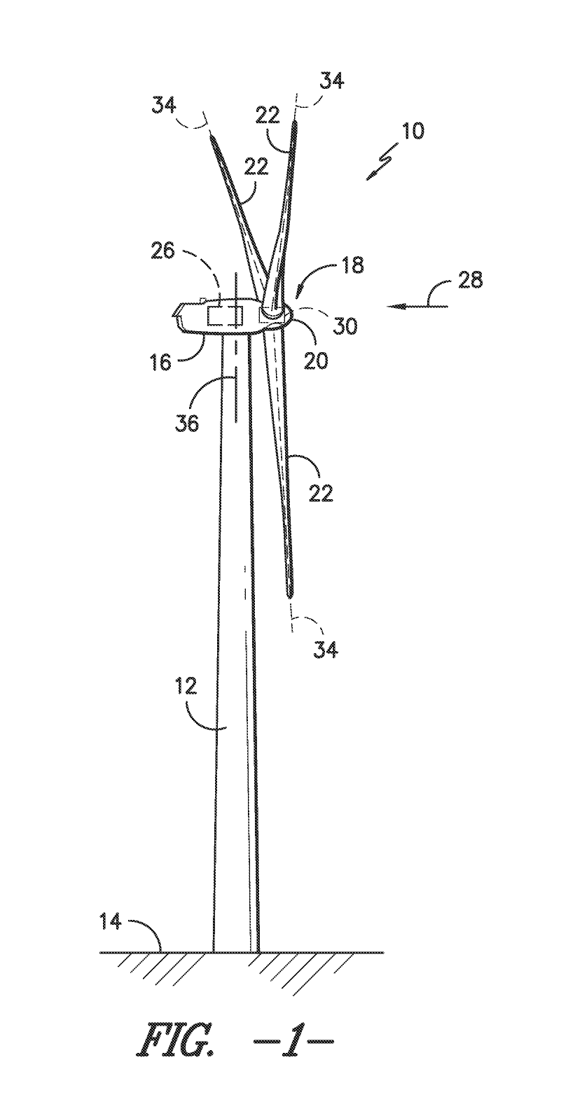

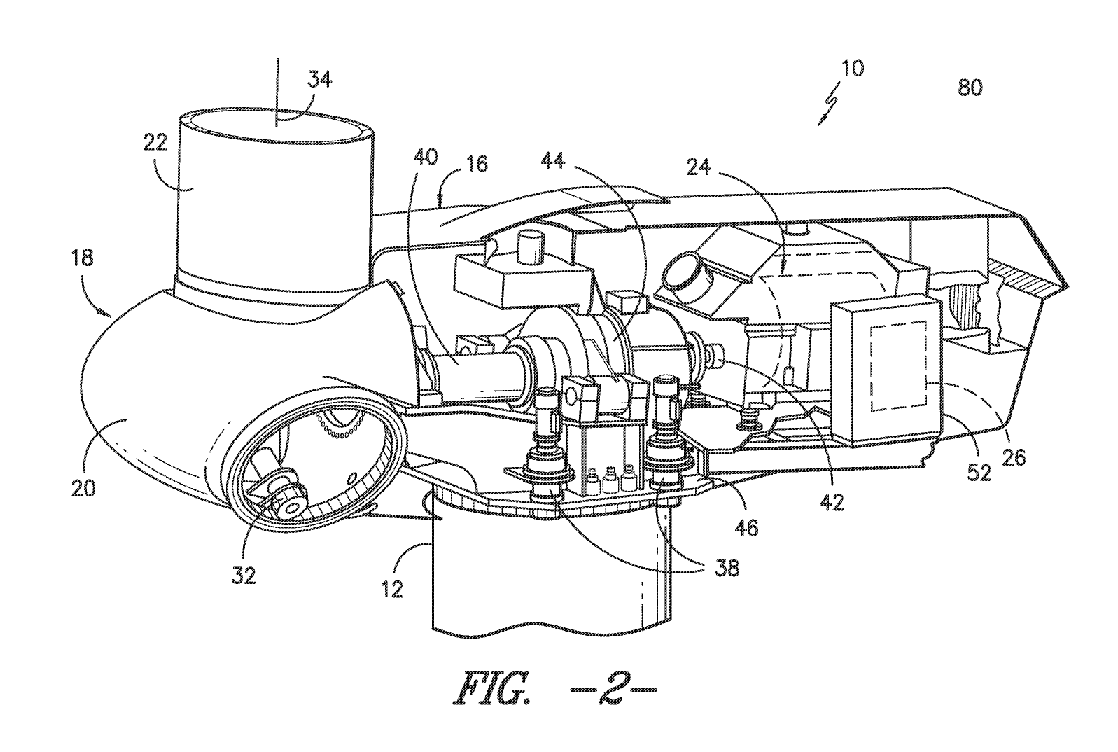

FIG. 1 illustrates a perspective view of one embodiment of a wind turbine 10. As shown, the wind turbine 10 includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator 24 (FIG. 2) positioned within the nacelle 16 to permit electrical energy to be produced.

As shown, the wind turbine 10 may also include a control system or a controller 26 centralized within the nacelle 16. However, it should be appreciated that the controller 26 may be disposed at any location on or in the wind turbine 10, at any location on the support surface 14 or generally at any other location. The controller 26 may generally be configured to control the various operating modes (e.g., start-up or shut-down sequences) and/or components of the wind turbine 10. Further, the controller 26 may generally be configured to control the operation of, for example, a power converter, discussed in detail below.

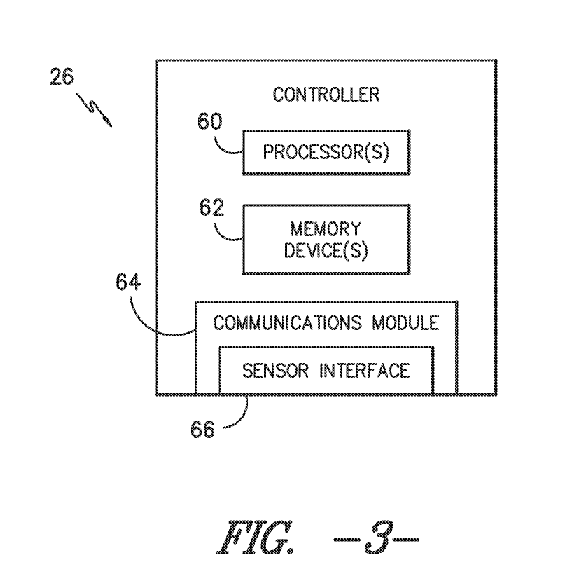

It should be appreciated that the controller 26 may generally comprise a computer or any other suitable processing unit. Thus, in several embodiments, the controller 26 may include one or more processor(s) and associated memory device(s) configured to perform a variety of computer-implemented functions, as shown in FIG. 3 and discussed herein. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) of the controller 26 may generally comprise memory element(s) including, but are not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) may generally be configured to store suitable computer-readable instructions that, when implemented by the processor(s), configure the controller 26 to perform various computer-implemented functions including, but not limited to, performing proportional integral derivative (“PID”) control algorithms, including various calculations within one or more PID control loops, and various other suitable computer-implemented functions. In addition, the controller 26 may also include various input/output channels for receiving inputs from sensors and/or other measurement devices and for sending control signals to various components of the wind turbine 10.

It should additionally be understood that the controller may be a singular controller or include various components which communicate with a central controller. For example, the controller may be solely a power converter controller, or may be a central controller which provides communication with respect to the controller and provides various other functions such as related to control of wind turbine pitch and yaw. Additionally, the term “controller” may also encompass a combination of computers, processing units and/or related components in communication with one another.

Referring now to FIG. 2, a simplified, internal view of one embodiment of the nacelle 16 of the wind turbine 10 is illustrated. As shown, a generator 24 may be disposed within the nacelle 16. In general, the generator 24 may be coupled to the rotor 18 of the wind turbine 10 for generating electrical power from the rotational energy generated by the rotor 18. For example, the rotor 18 may include a main rotor shaft 40 coupled to the hub 20 for rotation therewith. The generator 24 may then be coupled to the rotor shaft 40 such that rotation of the rotor shaft 40 drives the generator 24. For instance, in the illustrated embodiment, the generator 24 includes a generator shaft 42 rotatably coupled to the rotor shaft 40 through a gearbox 44. However, in other embodiments, it should be appreciated that the generator shaft 42 may be rotatably coupled directly to the rotor shaft 40. Alternatively, the generator 24 may be directly rotatably coupled to the rotor shaft 40 (often referred to as a “direct-drive wind turbine”).

It should be appreciated that the rotor shaft 40 may generally be supported within the nacelle by a support frame or bedplate 46 positioned atop the wind turbine tower 12. For example, the rotor shaft 40 may be supported by the bedplate 46 via a pair of pillow blocks 48, 50 mounted to the bedplate 46.

Additionally, as indicated herein, the controller 26 may also be located within the nacelle 16 of the wind turbine 10. For example, as shown in the illustrated embodiment, the controller 26 is disposed within a control cabinet 52 mounted to a portion of the nacelle 16. However, in other embodiments, the controller 26 may be disposed at any other suitable location on and/or within the wind turbine 10 or at any suitable location remote to the wind turbine 10.

The present disclosure is further directed to methods for operating wind turbines 10. In particular, controller 26 may be utilized to perform such methods and the steps thereof. Referring now to FIG. 3, there is illustrated a block diagram of one embodiment of suitable components that may be included within the controller 26 in accordance with aspects of the present subject matter. As shown, the controller 26 may include one or more processor(s) 60 and associated memory device(s) 62 configured to perform a variety of computer-implemented functions (e.g., performing the methods, steps, calculations and the like disclosed herein). Additionally, the controller 26 may also include a communications module 64 to facilitate communications between the controller 26 and the various components of the wind turbine 10. For instance, the communications module 64 may serve as an interface to permit the controller 26 to transmit control signals. Moreover, the communications module 64 may include a sensor interface 66 (e.g., one or more analog-to-digital converters) to permit input signals transmitted from, for example, various sensor or other components, to be converted into signals that can be understood and processed by the processors 60.

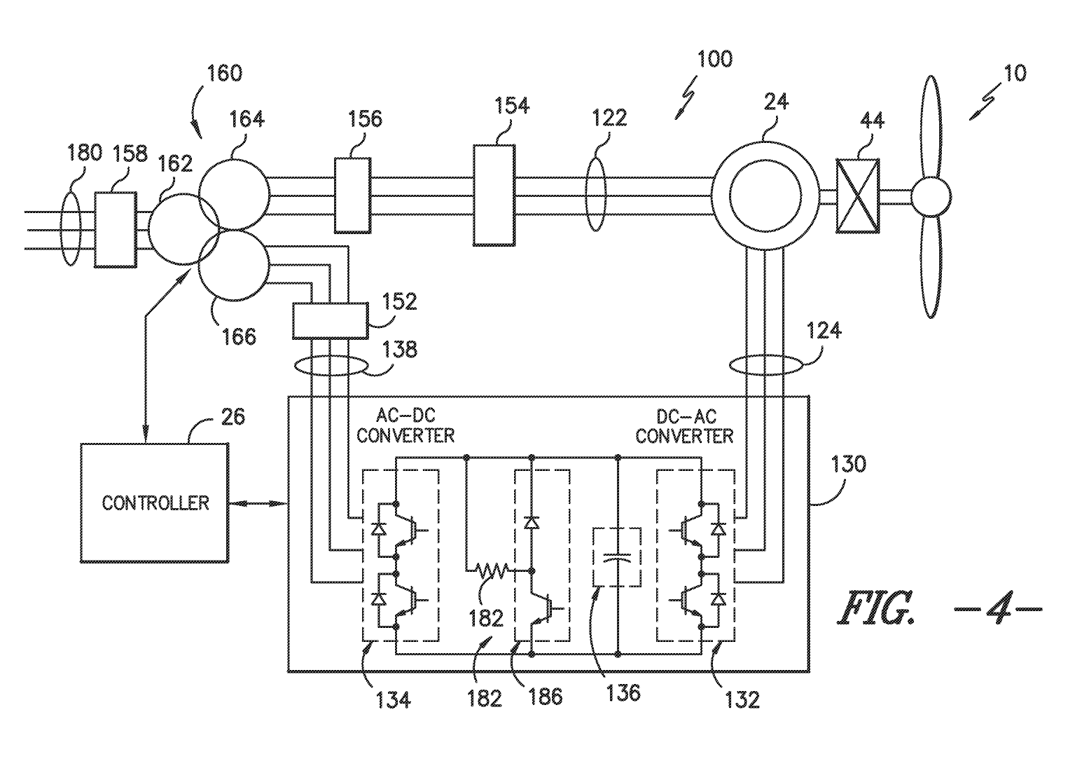

FIG. 4 depicts an exemplary doubly-fed induction generator (DFIG) wind turbine system 100 according to an exemplary embodiment of the present disclosure. In the exemplary system 100, wind turbine 10 includes, as discussed above, an optional gear box 44, which is, in turn, coupled to a generator 24. In accordance with aspects of the present disclosure, the generator 24 is a doubly fed induction generator (DFIG) 24. It should be understood, however, that the present disclosure is not limited to DFIG systems 100 and DFIGs 24, and rather that any suitable wind turbine system and generator, including for example full power conversion systems and generators, is within the scope and spirit of the present disclosure.

DFIG 24 is typically coupled to a stator bus 122 and a power converter 130 via a rotor bus 124. The stator bus 122 provides an output multiphase power (e.g. three-phase power) from a stator of DFIG 24 and the rotor bus 124 provides an output multiphase power (e.g. three-phase power) of the rotor of DFIG 24. Referring to the power converter 130, DFIG 24 is coupled via the rotor bus 124 to a rotor side converter 132 or plurality of rotor side converters 132, such as three converters 132 for a three-phase system. Each rotor side converter 132 is coupled to a line side converter 134 which in turn is coupled to a line side bus 138. One or more line side converters 134 may be included, such as three converters 134 for a three-phase system.

In exemplary configurations, the rotor side converter 132 and the line side converter 134 are configured for normal operating mode in a three-phase, pulse width modulation (“PWM”) arrangement using insulated gate bipolar transistors (IGBTs) as switching devices. Other suitable switching devices can be used, such as insulated gate commuted thyristors, MOSFETs, bipolar transistors, silicon controlled rectifiers, or other suitable switching devices. The rotor side converter 132 and the line side converter 134 can be coupled via a DC link 136 across which is a plurality of capacitors, one of which is illustrated, as discussed herein.

The power converter 130 can be coupled to controller 26 to control the operation of the rotor side converter 132 and the line side converter 134. For instance, the controller 26 can send control commands to the rotor side converter 132 and line side converter 134 to control the modulation of switching elements (such as IGBTs) used in the power converter 130 to provide a desired real and reactive power output. Switching elements may include, for example, one or more rotor side switches, which may be components of the rotor side converter 132, and one or more line side switches, which may be components of the line side converter 138, as discussed herein.

As illustrated, the system 100 includes a transformer 160 coupling the wind turbine system 100 to an electrical grid 180. The transformer 160 of FIG. 4 is a three-winding transformer that includes a high voltage (e.g. greater than 12 KVAC) primary winding 162 coupled to the electrical grid, a medium voltage (e.g. 6 KVAC) secondary winding 164 coupled to the stator bus 122, and a low voltage (e.g. 575 VAC, 690 VAC, etc.) auxiliary winding 166 coupled to the line bus 138. It should be understood that the transformer 160 can be a three-winding transformer as shown, or alternatively may be a two-winding transformer having only a primary winding 162 and a secondary winding 164; may be a four-winding transformer having a primary winding 162, a secondary winding 164, an auxiliary winding 166, and an additional auxiliary winding; or may have any other suitable number of windings.

In operation, power generated at DFIG 120 by rotating the rotor 106 is provided via a dual path to electrical grid 180. The dual paths are defined by the stator bus 122 and the rotor bus 124. On the rotor bus 124 side, sinusoidal multi-phase (e.g. three-phase) alternating current (AC) power is provided to the power converter 130. The rotor side power converter 132 converts the AC power provided from the rotor bus 124 into direct current (DC) power and provides the DC power to the DC link 135. Switching devices (e.g. IGBTs) used in parallel bridge circuits of the rotor side power converter 132 can be modulated to convert the AC power provided from the rotor bus 124 into DC power suitable for the DC link 135.

The line side converter 134 converts the DC power on the DC link 135 into AC power at a frequency suitable for the electrical grid 180. In particular, switching devices (e.g. IGBTs) used in bridge circuits of the line side power converter 134 can be modulated to convert the DC power on the DC link 135 into AC power on the line side bus 138. The power from the power converter 130 can be provided via the auxiliary winding 166 of the transformer 160 to the electrical grid 180.

The power converter 130 can receive control signals from, for instance, the controller 26. The control signals can be based, among other things, on sensed conditions or operating characteristics of the wind turbine system 100. For instance, the control signals can be based on sensed voltage associated with the transformer 160 as determined by a voltage sensor. As another example, the control signals can be based on sensed voltage associated with the auxiliary power feed 170 as determined by a voltage sensor.

Typically, the control signals provide for control of the operation of the power converter 130. For example, feedback in the form of sensed speed of the DFIG 120 can be used to control the conversion of the output power from the rotor bus 156 to maintain a proper and balanced multi-phase (e.g. three-phase) power supply. Other feedback from other sensors can also be used by the controller 140 to control the power converter 130, including, for example, stator and rotor bus voltages and current feedbacks. Using the various forms of feedback information, switching control signals (e.g. gate timing commands for IGBTs), stator synchronizing control signals, and circuit breaker signals can be generated.

On the stator bus 122 side, sinusoidal multi-phase (e.g. three-phase) alternating current (AC) power is provided from the stator of the generator 120 to the stator bus 122, and from the stator bus 122 to the transformer 160, and in particular to the secondary winding 164 thereof. Various circuit breakers, fuses, contactors, and other devices, such as grid circuit breaker 158, stator bus circuit breaker 156, stator switch 154, and line bus circuit breaker 152, can be included in the system 100 to connect or disconnect corresponding buses, for example, when current flow is excessive and can damage components of the wind turbine system 100 or for other operational considerations. Additional protection components can also be included in the wind turbine system 100.

Referring still to FIG. 4, a dynamic brake 182 may be provided in the power converter 130 between the rotor side converter 132 and the line side converter 134. The dynamic brake 182, when gated on, absorbs energy in the converter 130. For example, in exemplary embodiments as shown, a dynamic brake 182 may include a resistor 184 in series with a switch 186, which may for example be an IGBT.

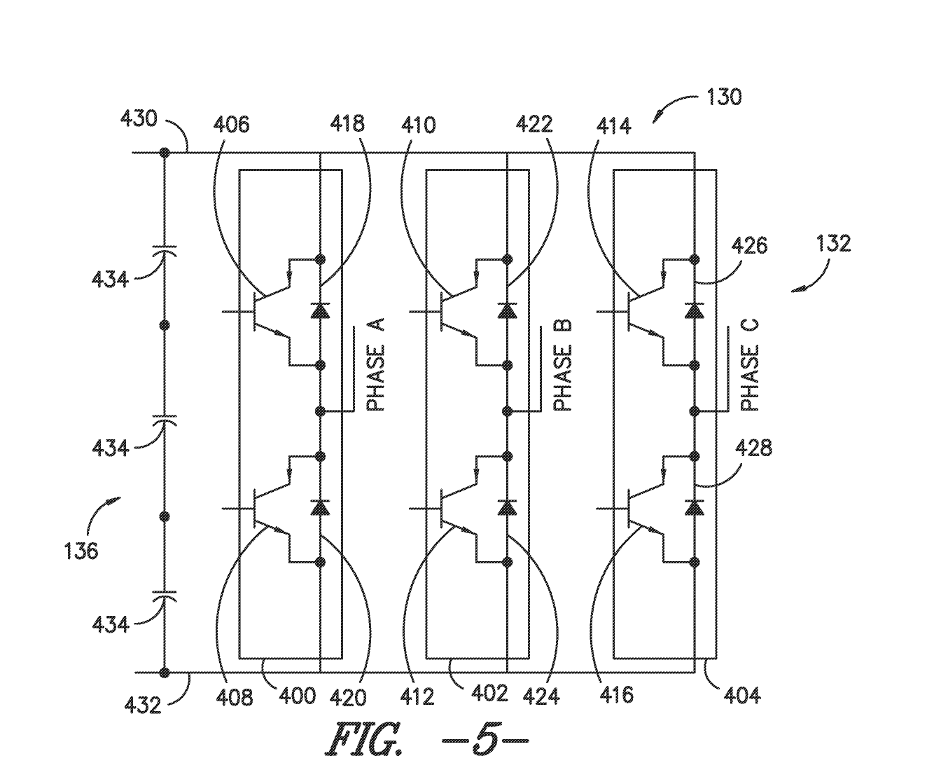

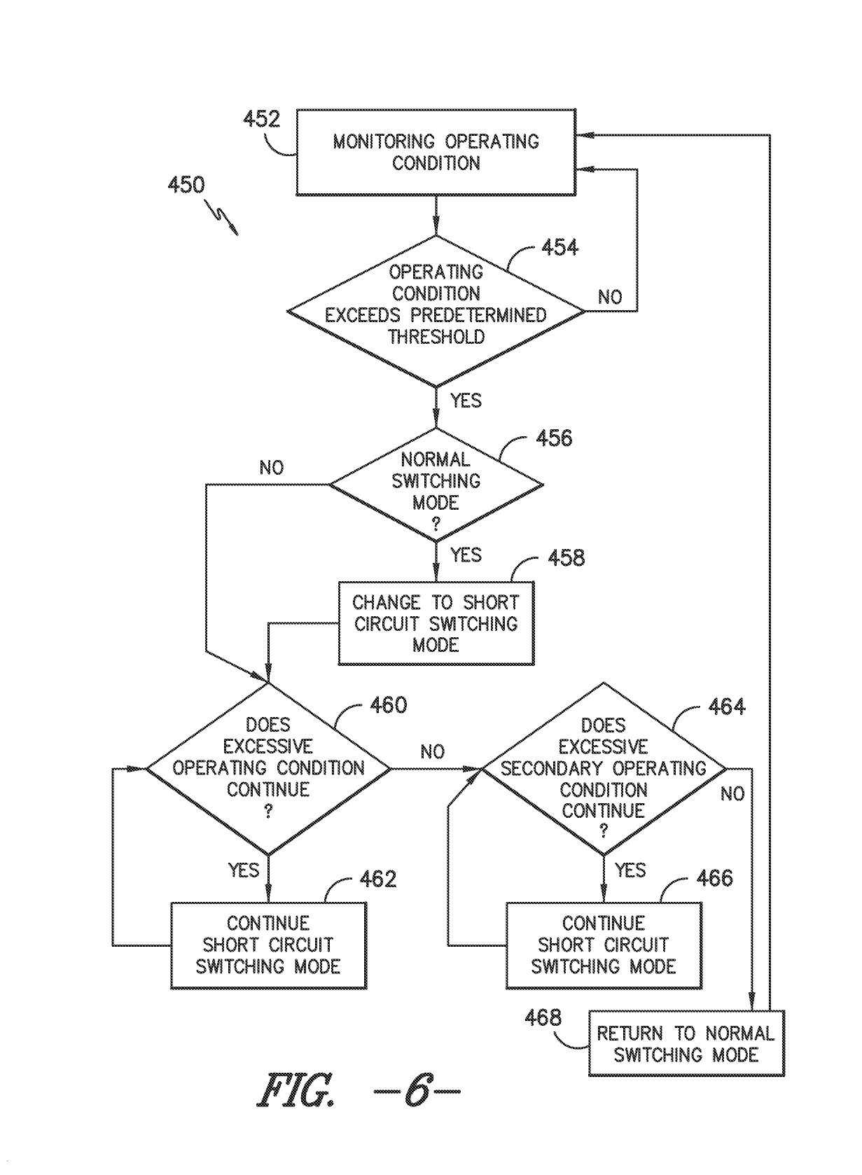

Referring now to FIGS. 5 and 6, the present disclosure is further directed to methods for operating the wind turbine system 100 which utilize the power converter 130, and specifically the rotor side converter 132 switches, to isolate power from the rotor bus 124 to the power converter 130. As discussed, the power converter 130 includes a plurality of switching devices, such as IGBT's. Although FIG. 5 illustrates switching devices that form the rotor side converter 132, a similar configuration may be used, for example, for the line side converter 134. Additionally, the switching devices may be modified or changed as desired or needed, with any suitable switching device, for example, any suitable transistor used. Further, additional switching devices or modules of switching devices may be used.

Referring to the rotor side converter 132 shown in FIG. 5, a plurality of switching devices are provided in connection with each power phase leg corresponding to each of the three-phases of the output power from the generator 24. Specifically, a first switching module 400, a second switching module 402 and a third switching module 404 are provided, each corresponding to a different phase of power output generated by the generator 24. Each of the switching modules 400, 402 and 404 include a pair of switching devices. In the various embodiments, the first switching module 400 includes a first switching device 406 and a second switching device 408; the second switching module 402 includes a first switching device 410 and a second switching device 412; and the third switching module 404 includes a first switching device 414 and a second switching device 416. Each of the switching devices 406-416 includes a corresponding diode 418, 420, 422, 424, 426 and 428, respectively.

In various embodiments, the switching devices 406-416 are configured as IGBTs wherein the gate of each of the IGBTs is connected to a control line and the diode 418-428 is connected between the emitter and the collector of the IGBTs. Thus, the switching or modulating of the IGBTs is controlled by a control signal provided to the gates of the IGBTs. The control signals may be provided from the controller 26. A power output line corresponding to one of the three power output phases is connected between the emitter of each of the first switching devices 406, 410 and 414, and the collector of each of the second switching devices 408, 412 and 416, of the first, second and third switching modules 400, 402 and 404, respectively.

Further, the collector of each of the first switching devices 406, 410 and 414 is connected to an upper rail 430, which in this embodiment is a positive voltage line (also referred to as a positive voltage rail), for example 1100 volts, and the emitter of each of the second switching devices 408, 412 and 416 is connected to a lower rail 432, which in this embodiment is a zero or negative voltage line (also referred to as a zero voltage rail or negative rail). Essentially, the upper rail 430 is at a positive capacitive voltage and the lower rail 432 is at a zero capacitive voltage relative to the negative rail. Additionally, one or more capacitors 434 in series and/or parallel are connected between the upper rail 430 and the lower rail 432. It should be noted that the three capacitors 434 are shown as a single capacitor in FIG. 4. The DC Link 136 may generally include these capacitors 434.

In operation, the switching devices 406-416 may be switched, for example, in a PWM manner to control the frequency of the power received from the generator 24 and provided to the transformer 160 (see FIG. 4). Referring to FIGS. 4 and 5, various embodiments of the present disclosure control the power flow from the rotor generated by the generator 24 using the rotor side converter 132. For example, during sensed transient or excessive voltage level conditions, the controller 26 may switch the switching devices 406-416 to form a short circuit among the leads of the rotor bus 124 of the generator 24. For example and for illustrative purposes only, during rated condition operation of the generator 24, the voltage at the terminals of the rotor bus 124 is greater than that voltage at the terminals of the stator bus 122. The effective turns ratio of the generator 24, may be, for example, in the range of 3:1 or higher. Further, and for example, the voltage level for the controlled DC link 136 between the rotor side converter 132 and the line side converter 134 is about 110% to 133% of the peak incoming AC voltage. For example, 1073 volts DC for a 575 volt RMS line to line 60 Hz system.

As a result, during various disturbances or conditions, transient voltage (referred to herein as a transient power condition) can be developed that exceeds the control capability of the rotor side converter 132. Various embodiments of the present disclosure provide a method for switching the switching devices 406-416 when a condition, for example, the transient condition is sensed, such as, when the voltage at the DC link 136 exceeds a normal control level above or within a predetermined range of a maximum rated operating voltage. Upon sensing this condition or other excessive power condition, the controller 26 changes the switching operation of the switching devices 406-416 of the power converter 130 from normal switching, such as PWM switching (collectively referred to as normal switching mode), to a switching scheme that forms an electrical short circuit among the phases of the rotor circuit (short circuit switching mode). This change in switching operation blocks further increase in power flow from the generator 24 to the DC link 136 and allows the control action of the line side converter 134 to continue to extract power from the DC link 136 and deliver power to the transformer 160, and thus to the grid 180.

Once the excessive voltage has been removed from the DC link 136 (e.g., transient has dissipated), the switching of the power converter 130 returns to a normal switching mode, which in various embodiments is a PWM sinusoidal switching pattern. The voltage levels for changing the switching scheme may be predetermined, for example, the levels for the control decisions may be VDC nominal at 1073 volts, excess voltage level to initiate short circuit firing is 1230 volts, and the level for return to normal firing is 1100 volts.

Additionally, before switching of the power converter 130 returns to the normal switching mode, the rotor current magnitude may be measured to ensure that excessive current has been removed. For example, during the short circuit switching mode, current magnitude and peak current from the rotor bus 124 may be measured. A peak current level for changing the switching scheme may be predetermined. Accordingly, once the peak current from the rotor bus 124 is below the predetermined level, the switching of the power converter 130 returns to a normal switching mode.

In exemplary embodiments, both the voltage level and the current level must be below the respective predetermined levels for the switching of the power converter 130 to return from the short circuit switching mode to the normal switching mode. Advantageously, such approach may prevent spikes in the voltage level due to excessive current levels that remain in the circuit. Accordingly, loops of switching between the short circuiting mode and the normal operating mode, as well as damage to the power converter components and other components of the system and failure of the system 100 to ride through grid events, can be reduced or prevented.

More particularly, in various embodiments of the invention, a method 450 for operating the wind turbine system 100 which provides for isolating power to the rotor side of the power converter 130, and in particular, the rotor side converter 132 is provided by controlling the switching of the switching devices of the power converter 130. Specifically, as shown in FIG. 6, the method 450 includes monitoring at least one operating condition of the wind turbine system 100, for example, an operating condition of the power converter 130. This may include, for example, monitoring the voltage level at the DC link between the rotor side converter and line side converter. However, the monitoring is not limited to monitoring the voltage level at the DC link and may include monitoring other links or points within the wind turbine system, and generally may include monitoring different voltage and/or current levels, and/or changes in such levels.

At 454 a determination is made as to whether the operating condition exceeds a predetermined threshold, which may be, for example, a predefined threshold based on the operating parameters of the generator 24. For example, a determination may be made as to whether the DC voltage at the DC link has exceeded a predetermined voltage level above the normal operating voltage at the DC link. This determination may be made based upon, for example, an absolute voltage increase above the normal operating voltage or a percentage voltage increase above the normal operating voltage. This monitoring may be provided on a continuous basis, periodically, at predetermined time intervals, at predetermined times, etc.

If it is determined at 454 that the predetermined threshold has not been exceeded then the monitoring continues at 452. If a determination is made at 454 that the predetermined threshold has been exceeded, then a determination is made at 456 as to whether the power converter 130, and in particular the rotor side converter 132 of the power converter 130 is in a normal switching mode (e.g., PWM switching mode). If the power conversion component is in a normal switching mode, then at 458, the switching of the switching devices of the rotor side converter 132 of the power converter 130 are changed to a short circuit switching mode in which a short circuit is formed among the leads of the rotor bus 124 of the generator 24. In this short circuit switching mode the switching devices of the power converter 130 are controlled such that all of the second switching devices 408, 412, 416 are switched “on” or conducting, thereby connecting each of the power output phase legs to the bottom rail (zero capacitive voltage). All of the first switching devices 406, 410, 414 are switched “off” or non-conducting. After a predetermined time period, which in an exemplary embodiment, is longer that the switching interval during the normal switching mode, all of the first switching devices are switched “on” or conducting, thereby connecting each of the power output phase legs to the top rail (positive capacitive voltage). All of the second switching devices are switched “off” or non-conducting. Thus, the frequency at which the individual rotor converter phase legs are switched from conducting to blocking states is reduced from the normal switching rate. For example, at normal switching rates, each switching device may switch at 3808 switches per second and in the short circuit switching mode each switching device switches at a rate of 50 switches per second.

Thereafter, at 460 a determination is made as to whether the excessive condition continues, for example, whether the excessive voltage level at the DC link continues above the predetermined threshold, also referred to as a first predetermined threshold. In various other embodiments, a determination is made to whether the voltage level has decreased below a second predetermined threshold that is above the first predetermined threshold. If the condition continues, for example, if the voltage level is above the first and/or second predetermined threshold levels, then at 462, the short circuit switching mode continues and a determination is again made at 460 after, for example, a predetermined time period, as to whether the excessive condition continues.

Additionally, at 464 a determination is made as to whether an excessive secondary operating condition exists, for example, whether an excessive current level from the rotor bus 124 exists above a secondary predetermined threshold. Such determination may be made before, during, or after the determination at step 460. In the embodiment as illustrated, the determination at step 464 occurs after the determination at step 460 is made, and after it is determined that the condition does not continue. Referring again to step 464, if the secondary operating condition continues, for example, if the current level is above the secondary predetermined threshold level, then at 466, the short circuit switching mode continues and a determination is again made at 464 after, for example, a predetermined time period, as to whether the excessive condition continues.

If at 460 a determination is made that the first excessive condition does not continue, i.e. the operating condition is less than then predetermined threshold, but at 464 a determination is made that the second excessive condition does continue; i.e. the secondary operating condition is greater than or equal to the secondary predetermined threshold, the short circuit switching mode continues and a determination is again made at 464 (and may also be again made at 460) after, for example, a predetermined time period, as to whether the excessive condition continues.

If at 460 a determination is made that the condition does not continue, i.e. the operating condition is less than then predetermined threshold, and at 464 a determination is made that the second excessive condition does not continue, i.e. the secondary operating condition is less than the secondary predetermined threshold, then switching returns to the normal switching mode at 468. Thereafter, monitoring continues at 452. Referring again to the determination at 456 as to whether the power converter 130, and in particular the rotor side converter 132 of the power converter 130 is in a normal switching mode, if the power converter 130 is not in the normal switching mode, and thus is in short circuit switching mode, a determination is made at 460 as to whether the excessive condition that previously caused the switch to the short circuit switching mode continues and a determination is made at 464 as to whether the secondary excessive condition exists.

Using various embodiments of the present disclosure, the control of power flow during the disturbance event from normal operation, to rotor generation of excess power and voltage (e.g., transient voltage condition), to imposed rotor terminal short circuit, and back to normal operation after the disturbance, is provided using switching commands from, for example, the controller 26 to the switching devices of the power converter 130. Using normal and short circuit switching modes and corresponding switching control patterns, a short circuit is provided among the leads of the rotor bus 124 of the generator 24.

Thus, in various embodiments of the present disclosure the controller isolates power to the power converter by controlling the power converter to effectively deliver the application of zero output volts. In the various embodiments, switches are together alternatively switched between an all up conduction state and an all down conduction state regardless of the current direction. Further, the base switching frequency for the rotor side converter 132 is lowered during the short circuit switching mode. Additionally, any torque peaks can be reduced by controlling the rotor converter switching between the short circuit and normal PWM switching modes to limit the current ramp.

Further, monitoring of multiple operating conditions, for example a first operating condition such as voltage and a second operating condition such as current, during switching may advantageously reduce the risk of spikes in the voltage level and damage to components of the system 100 during switching from the short circuit switching mode to the normal switching mode.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for operating a wind turbine system, the method comprising:
monitoring an operating condition of the wind turbine system;
determining whether the operating condition has exceeded a predetermined threshold;
switching a plurality of switches devices in a rotor side converter of a power converter of the wind turbine system in a normal switching mode if the operating condition is less than the predetermined threshold;
switching the plurality of switching devices in a short circuit switching mode if the operating condition is greater than or equal to the predetermined threshold;
switching the plurality of switching devices in the normal switching mode after switching in the short circuit mode if the operating condition decreases below the predetermined threshold and a secondary operating condition is below a secondary predetermined threshold.

2. The method of claim 1, wherein the operating condition is a voltage level at a DC link between the rotor side converter and a line side converter of the power converter.

3. The method of claim 1, wherein the secondary operating condition is a current level from a rotor bus of the wind turbine system.

4. The method of claim 1, further comprising continuing switching the plurality of switching devices in the short circuit mode if the operating condition decreases below the predetermined threshold and the secondary operating condition is greater than or equal to the secondary predetermined threshold.

5. The method of claim 1, further comprising continuing switching the plurality of switching devices in the short circuit mode if the operating condition remains greater than or equal to the predetermined threshold.

6. The method of claim 1, further comprising continuing switching the plurality of switching devices in the short circuit mode if the secondary operating condition remains greater than or equal to the secondary predetermined threshold.

7. The method of claim 1, wherein switching the plurality of switching devices in the normal switching mode comprises switching using pulse width modulation switching.

8. The method of claim 1, wherein switching the plurality of switching devices in the short circuit switching mode comprises switching each of a plurality of first switching devices to a conducting state and switching each of a plurality of second switching devices to a non-conducting state, the first switching devices connected to a positive capacitive voltage.

9. The method of claim 1, wherein switching the plurality of switching devices in the short circuit switching mode comprises switching each of a plurality of second switching devices to a conducting state and switching each of a plurality of first switching devices to a non-conducting state, the second switching devices connected to a negative capacitive voltage.

10. The method of claim 1, wherein each of the plurality of switching devices comprises an insulated gate bipolar transistor.

11. A wind turbine system, comprising:
a generator for generating power;
a rotor bus operable to provide three-phase power from a rotor of the generator;
a power converter connected to the rotor bus, the power converter comprising a line side converter and a rotor side converter, the rotor side converter comprising a plurality of switching devices; and
a controller in communication with the power converter, the controller operable to:
switch the plurality of switching devices in a short circuit switching mode if an operating condition is greater than or equal to a predetermined threshold; and
switch the plurality of switching devices in the normal switching mode after switching in the short circuit mode if the operating condition decreases below the predetermined threshold and a secondary operating condition is below a secondary predetermined threshold.

12. The wind turbine system of claim 11, wherein the controller is further operable to:
monitor the operating condition;
determine whether the operating condition has exceeded a predetermined threshold;
and switch the plurality of switches devices in the normal switching mode if the operating condition is less than the predetermined threshold.

13. The wind turbine system of claim 11, wherein the operating condition is a voltage level at a DC link between the rotor side converter and a line side converter of the power converter.

14. The wind turbine system of claim 11, wherein the secondary operating condition is a current level from a rotor bus of the wind turbine system.

15. The wind turbine system of claim 11, wherein the controller is further operable to continue switching the plurality of switching devices in the short circuit mode if the operating condition decreases below the predetermined threshold and the secondary operating condition is greater than or equal to the secondary predetermined threshold.

16. The wind turbine system of claim 11, wherein the controller is further operable to continue switching the plurality of switching devices in the short circuit mode if the operating condition remains greater than or equal to the predetermined threshold.

17. The wind turbine system of claim 11, wherein the controller is further operable to continue switching the plurality of switching devices in the short circuit mode if the secondary operating condition remains greater than or equal to the secondary predetermined threshold.

18. The wind turbine system of claim 11, wherein switching the plurality of switching devices in the short circuit switching mode comprises switching each of a plurality of first switching devices to a conducting state and switching each of a plurality of second switching devices to a non-conducting state, the first switching devices connected to a positive capacitive voltage, and then switching each of a plurality of second switching devices to the conducting state and switching each of a plurality of first switching devices to the non-conducting state, the second switching devices connected to a negative capacitive voltage.

19. The wind turbine system of claim 11, wherein each of the plurality of switching devices comprises an insulated gate bipolar transistor.

20. The wind turbine system of claim 11, wherein the generator is a doubly fed induction generator.
